(19) United States
(12) Patent Application Publication
(10) Pub. No.: US 2002/0131612 A1
(43) Pub. Date: Sep. 19, 2002

(54) Dual magnetic structure of vibration speaker

(75) Inventor: Yeon Ho Son, Suwon-Shi (KR)

Correspondence Address: DARBY & DARBY P.C., 805 Third Avenue, New York, NY, 10022, US

(73) Assignee: SAMSUNG ELECTRO-MECHANICS CO., LTD., Suwon-Shi (KR)

(21) Appl. No.: 09/893,172

(22) Filed: Jun. 27, 2001

(30) Foreign Application Priority Data
Mar. 16, 2001 (KR) 2001-13779

(51) Int. Cl. H04R 25/00

(52) U.S. Cl. 381/150; 381/412

(57) ABSTRACT

Disclosed is a multifunction actuator comprising: a case having an internal space; a sound generating diaphragm with the outer end fixed to the upper end of the case; a voice coil cylindrically wound and fixed around the lower end of the diaphragm; a main magnet magnetized in the upward and downward directions; an upper plate attached to the magnet for forming a magnetic circuit; a yoke for forming the magnetic circuit with the magnet; a weight for forming a vibrating body with the upper plate and the yoke; suspension springs for supporting the weight from the upside and downside; a vibrating coil installed in the lower end of the case for generating vibration by using a portion of magnetic flux generated as above; and a ring-shaped auxiliary magnet installed in the yoke; wherein the magnetic circuit is provided to increase strength of magnetic flux under the same pressure while defining the same magnetic field as previous one so that sound pressure and vibration features of the multifunction actuator of the vibration speaker used in the mobile communication terminals such as the cellular phone, the pager and the like can be enhanced.

### BACKGROUND OF THE INVENTION

1. Field of the Invention

The present invention relates to a multifunction actuator for generating sound and vibration at the same time, in particular, a multifunction actuator to have a raised audio and vibration output under the same input by increasing the magnetic flux flowing in the actuator.

2. Description of the Related Art

In general, a speaker is a sound generating equipment for outputting electrically or electronically received audio signals or prerecorded bells or melodies in a sound audible to man. Such a speaker function recently has been used in mobile communication means including a cellular phone, however, has confronted restrictions in use for the purpose of preventing noise created therefrom in public places. Instead, the frequency of using vibration as a call incoming signal has increased and the requirements for the multifunction actuator are increasing for satisfying these functions.

Therefore, recently, development has been actively performed about such a multifunction actuator capable of performing such basic functions while integrating parts such as a vibration motor, a buzzer, a receiver, a speaker and the like used in the mobile communication means such as the cellular phone to reduce the spatial size thereof.

However, relative function decrease is essentially incurred in order to obtain several functions at the same time. Therefore, it has been required to develop an actuator having a more powerful magnetic circuit capable of overcoming such a problem, and more urgently to develop a multifunction actuator in an economic aspect of saving unit cost of each part.

The invention is disclosed about the multifunction actuator for improving the structure of a magnet composing the magnetic circuit of the prior art to realize higher audio output and vibration performance, wherein the same principle can be applied to a micro speaker composing the basis of the operating principle of the multifunction actuator to obtain sound pressure much higher than conventional output sound pressure.

As shown in FIG. 1, the multifunction actuator has a voice coil in a diaphragm side of a magnetic circuit block to output sound when an AC current is applied to the voice coil, and a vibrating coil in the lower magnetic circuit to generate vibration when the current is applied to the lower coil.

Describing in detail about the conventional structure hereinafter, the multifunction actuator comprises a case 8 having an internal space area, a magnet 4 internally contained in the case 8, a voice coil 2 and a diaphragm 1 for finally generating sound as shown in FIG. 1.

In such a multifunction actuator, when a high-frequency AC current is applied to a voice coil 2 in the magnetic circuit composed of an upper plate 3, the magnet 4 magnetized in the upward and downward directions and a yoke 5, electromagnetic force is generated for audio output. In other words, magnetic lines of force from the N pole of the magnet 4 proceed to the S pole through the upper plate 3, the voice coil 2 and the yoke 5 in sequence to form a magnetic field, in which the voice coil functions as a speaker by using magnetic flux from the magnetic circuit.

Meanwhile, a low frequency AC signal applied to the voice coil 2 promotes vertical movement of parts composing the magnetic field and a vibration body including a weight 6 to generate vibration.

However, in such a structure, it is difficult to generate a sufficient amount of vibration when generating audio and vibration signals by using the voice coil only. Also, there are several problems such as overlap of frequencies since the sound and vibration are generated in a frequency band inputted into the same source. Therefore, an additional coil is used for generating vibration.

In other words, referring to FIG. 2, an improved structure comprises a case 18 with an internal space, a magnet 14 internally contained within the case 18, a voice coil 12, a diaphragm 11 and an additional vibrating coil 20.

In such a multifunction actuator, a magnetic field is generated in the voice coil 12 in a magnetic circuit comprising an upper plate 13, the magnet 14 magnetized in the upward and downward directions and a yoke 15 when the AC current is externally applied through a lead line (not shown), in which distribution of the magnetic lines of force can be expressed as in FIG. 3. As shown in FIG. 3, magnetic lines of force from the N pole of the magnet 14 proceed to the S pole through the upper plate 13, the voice coil 12 and the yoke 15 in sequence to form the magnetic field, in which the voice coil functions as a speaker by using magnetic flux from the magnetic circuit.

Meanwhile, the yoke 15 is thinner in the lower end of than in the sides so that a portion of magnetic flux such as the magnetic lines of force shown in FIG. 3 is leaked toward the vibrating coil 20 to create electromagnetic force thereto.

However, since a portion of magnetic flux is shared in this case to reduce strength thereof, electromagnetic force is not generated sufficiently in the lower vibrating coil.

Since magnetic flux which can be generated in the vibrating coil 20 is proportional to the current multiplied with the winding number in general, it has been proposed to increase strength of the current in order to avoid a magnetic flux lacking phenomenon as above, which, however, incurs a problem that battery capacity should be enhanced. Resultantly, it is required to solve the magnetic flux lacking phenomenon in a restricted range of current.

### SUMMARY OF THE INVENTION

The present invention is proposed to solve the foregoing problems and it is therefore an object of the invention to compose a magnetic circuit the same as a previous magnetic circuit, which is capable of enhancing strength of magnetic flux under the same input power, by which sound pressure and vibration features of a multifunction actuator of a vibration speaker used in mobile communication terminals such as a cellular phone, a pager and the like can be improved.

According to an embodiment of the invention to obtain the foregoing object, it is provided a multifunction actuator comprising: a case having an internal space; a sound generating diaphragm with the outer end fixed to the upper end of the case; a voice coil cylindrically wound and fixed around the lower end of the diaphragm; a main magnet magnetized in the upward and downward directions; an upper plate attached to the magnet for forming a magnetic circuit; a yoke for forming the magnetic circuit with the magnet; a weight for forming a vibrating body with the upper plate and the yoke; suspension springs for supporting the weight from the upside and downside; a vibrating coil installed in the lower end of the case for generating vibration by using a portion of magnetic flux generated as above; and a ring-shaped auxiliary magnet installed in the yoke; wherein the magnetic circuit is provided to increase strength of magnetic flux under the same pressure while defining the same magnetic field as previous one so that sound pressure and vibration features of the multifunction actuator of the vibration speaker used in the mobile communication terminals such as the cellular phone, the pager and the like can be enhanced.

### BRIEF DESCRIPTION OF THE DRAWINGS

FIG. 1 is a sectional view for showing an example of a multifunction actuator of the prior art;

FIG. 2 is a sectional view for showing another example of the multifunction actuator of the prior art;

FIG. 3 shows magnetic lines of force of the multifunction actuator of the prior art;

FIG. 4 is a sectional view of a multifunction actuator according to the first embodiment of the invention;

FIG. 5 shows magnetic lines of force according to the first embodiment of the invention;

FIG. 6 is a sectional view of a multifunction actuator according to the second embodiment of the invention;

FIG. 7 is a sectional view of a multifunction actuator according to the third embodiment of the invention; and

FIG. 8 is a sectional view of a multifunction actuator according to the fourth embodiment of the invention.

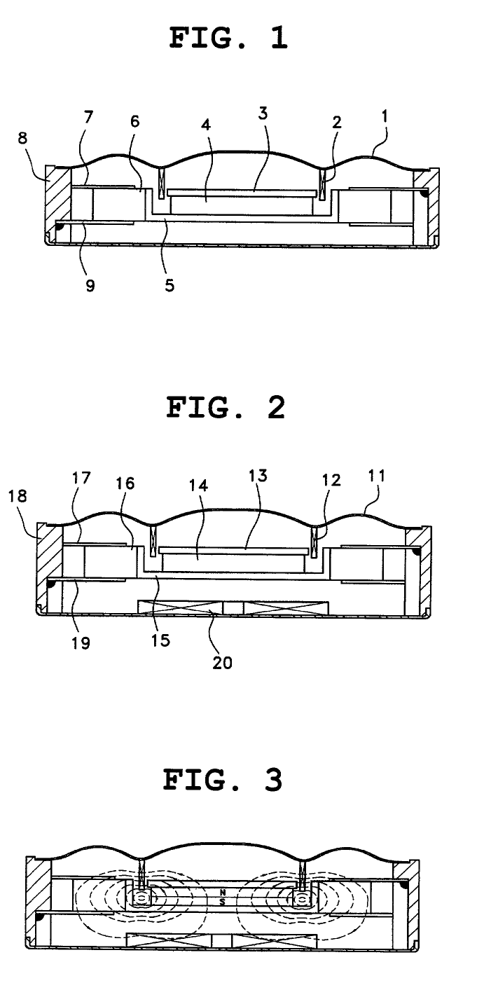

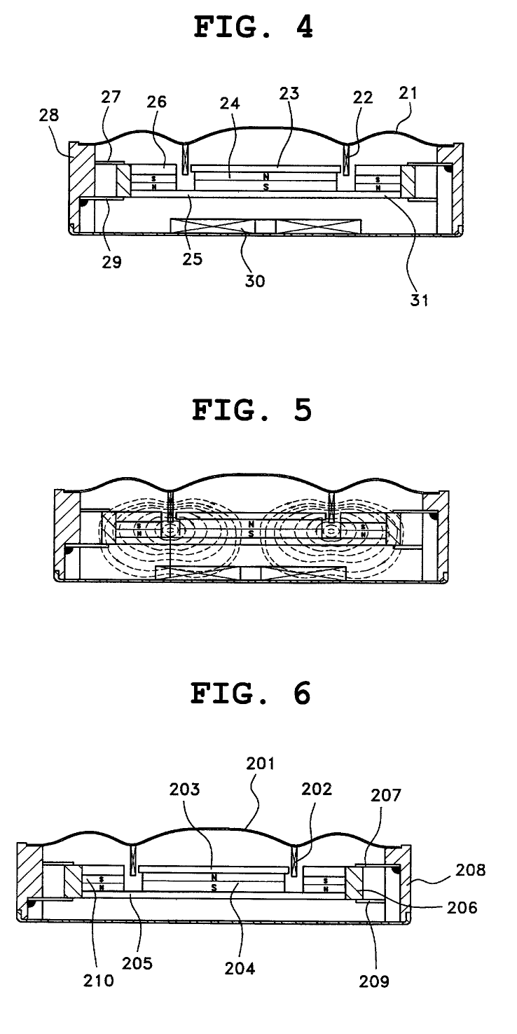

### DESCRIPTION OF THE PREFERRED EMBODIMENTS

The present invention relates to adding a ring-shaped auxiliary magnet in a yoke region, by which magnetic force is also generated in the peripheral ring-shaped magnet while magnetic force was generated only in a cylindrical magnet at a central portion in the prior art, thereby increasing magnet volume for generating magnetic force.

Hereinafter describing in detail about a multifunction actuator according to the first embodiment of the invention, the actuator comprises a case 28 having an internal space, a sound generating diaphragm 21 with the outer end fixed at the upper end of the case 28, a voice coil 22 cylindrically wound and fixed around the lower end of the diaphragm 21, a main magnet 24 contained within the case 28 and magnetized in the upward and downward directions, an upper plate 23 attached to the main magnet 24 for forming a magnetic circuit, a yoke 25 for forming a magnetic circuit with those components, a weight 26 for composing a vibrating body with the upper plate 23 and the yoke 25, suspension springs 27 and 29 for supporting the weight 26 from the upside and downside thereof, a vibrating coil 30 installed in the lower end of the case for generating vibration by using a portion of magnetic flux generated in such a manner, and a ring-shaped auxiliary magnet 31 installed in the yoke 25.

In the multifunction actuator like this, when an AC current is externally applied in general, magnetic field is generated in the voice coil 22 in the magnetic circuit composed of the upper plate 23, the magnet 24 and the yoke 25, in which distribution of magnetic lines of force can be indicated as shown in FIG. 5. As shown in FIG. 5, the magnetic lines of force from the N pole of the main magnet 24 proceed to the S pole of the main magnet 24 through the upper plate 23, the voice coil 22, the yoke 25 upper part, the auxiliary magnet 31 and the yoke 25 lower part in sequence to form magnetic field, in which the voice coil 22 functions as a speaker by using magnetic flux due to the above magnetic circuit.

Meanwhile, the vibrating coil 30 generates magnetic force by using a portion of magnetic flux leaks downward as the magnetic lines of force as shown in FIG. 5 at the lower end of the yoke 25, in which the whole volume of the magnet can be increased if the auxiliary magnet 31 is used. Therefore, the vibrating coil 30 can be supplied with sufficient strength of magnetic flux differently from the structure of the prior art.

Here, it is required that the auxiliary magnet 31 is shaped as a ring and has pole directions oriented differently from those of the main magnets 24 so that the directions of the magnetic lines of force may not be changed.

As described above, the invention is characterized in that the magnetic circuit maintains similar to that of the prior art and at the same time can increase the amount of magnetic flux leaking downward so that a sufficient amount of magnetic flux can be supplied to generate electromagnetic force to the vibrating coil. Here, output sound pressure is raised 2 to 3 dB on the average and vibration performance shows the enhancement of about 15% in the case of using the auxiliary magnet disclosed in the invention.

The multifunction actuator structure using dual magnets can be realized in various forms, in which the second embodiment of the invention can be represented as in FIG. 6.

A multifunction actuator according to the second embodiment comprises a case 208 having an internal space, a sound generating diaphragm 201 with the outer end fixed to the upper end of the case 208, a voice coil 202 cylindrically wound and fixed around the lower end of the diaphragm 201, a main magnet 204 magnetized in the upward and downward directions, an upper plate 203 attached to the magnet 204 for forming a magnetic circuit, a yoke 205 for forming the magnetic circuit with the magnet 204, a weight 206 for forming a vibrating body with the upper plate 203 and the yoke 205, suspension springs 207 and 209 for supporting the weight 206 from the upside and downside thereof, and a ring-shaped auxiliary magnet 210 installed in the yoke 205.

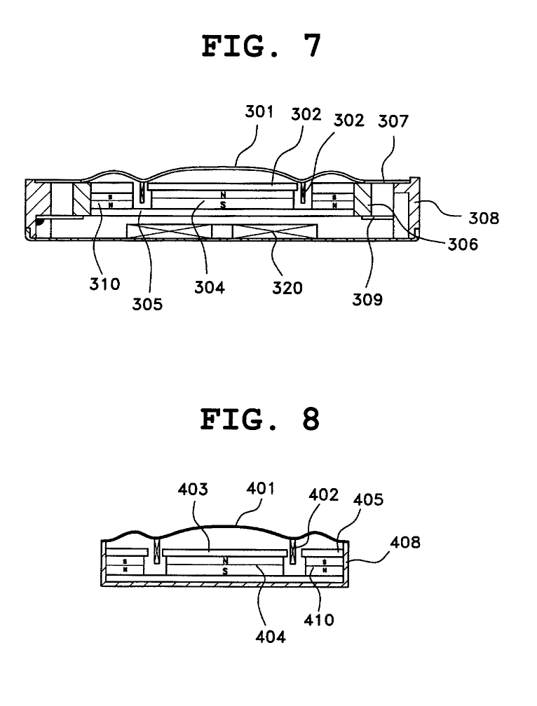

The third embodiment of the invention can be represented as in FIG. 7.

A multifunction actuator according to the third embodiment of the invention comprises a case 308 having an internal space, a main magnet 304 magnetized in the upward and downward directions, an upper plate 303 attached to the magnet for forming a magnetic circuit, a yoke 305 for forming the magnetic circuit with the magnet 304, a weight 306 for forming a vibrating body with the upper plate 303 and the yoke 305, suspension springs 307 and 309 supporting the weight 306 from the upside and downside thereof, a sound generating diaphragm 301 directly connected to one end of the weight 306, a voice coil 302 cylindrically wound and fixed around the lower end of the diaphragm 301, a vibrating coil 320 installed in the lower end of the case 308 for generating vibration by using a portion of magnetic flux generated in such a manner, and a ring-shaped auxiliary magnet 310 installed in the vibrating coil 320 and the yoke 305.

The operative principles of the second and third embodiments of the invention are similar to that of the first embodiment of the invention and therefore the explanation thereof will be omitted.

Also, the dual magnet structure of the invention can be variously applied to a micro speaker with a magnetic circuit block having a similar structure to that of the multifunction actuator thereby permitting a very large area of application.

FIG. 8 shows a micro speaker employing the dual magnet structure.

The micro speaker generally comprises a case 408 having an internal space, a sound generating diaphragm 401 with the outer end fixed to the upper end of the case 408, a voice coil 402 cylindrically wound and fixed around the lower end of the diaphragm 401, a main magnet 404 magnetized in the upward and downward directions, an upper plate 403 attached to the magnet 404 for forming a magnetic circuit, and a yoke 405 for forming the magnetic circuit with the magnet 404, in which an auxiliary magnet 410 of the invention is installed in a ring shape to define a dual magnetic structure.

Considering the operative principle, when a high-frequency AC current is externally applied in general to the voice coil 402 in the magnetic circuit composed of the upper plate 403, the main magnet 404 and the yoke 405, electromagnetic force is generated for audio output, in which magnetic lines of force from the N pole of the main magnet 404 proceed to the S pole of the main magnet through the upper magnet 403, the voice coil 402, the yoke 405 upper part, the auxiliary magnet 410 and the yoke lower part in sequence to form magnetic field. Here, the voice coil 402 functions as a speaker by using magnetic flux due to the magnetic circuit. Here, it is required that the auxiliary magnet 410 is shaped as a ring and has pole directions oriented differently from those of the main magnets 404 so that the directions of the magnetic lines of force may not be changed.

It will be clarified that the structures described as above in realizing the invention are only embodiment whereas different forms of apparatuses can be made by those skilled in the art from the scope and the basic principle of the invention recorded in claims of the invention.

According to the invention, when magnet volume is increased, magnetic flux flowing through the magnetic circuit is enhanced to raise audio and vibration output even under the same pressure. Also, the principle can be variously applied to speakers which are currently used to have a large area of application.

What is claimed is:

1. A multifunction actuator comprising:
a case having an internal space;
a sound generating diaphragm with the outer end fixed to the upper end of said case;
a voice coil cylindrically wound and fixed around the lower end of said diaphragm;
a main magnet magnetized in the upward and downward directions;
an upper plate attached to said magnet for forming a magnetic circuit;
a yoke for forming the magnetic circuit with said magnet;
a weight for forming a vibrating body with said upper plate and said yoke;
suspension springs for supporting said weight from the upside and downside;
a vibrating coil installed in the lower end of said case for generating vibration by using a portion of magnetic flux generated as above; and
a ring-shaped auxiliary magnet installed in said yoke.

2. A multifunction actuator according to claim 1, wherein said auxiliary magnet has pole directions oriented differently from those of the main magnets whereby the directions of the magnetic lines of force may not be changed.

3. A multifunction actuator comprising:
a case having an internal space;
a sound generating diaphragm with the outer end fixed to the upper end of said case;
a voice coil cylindrically wound and fixed around the lower end of said diaphragm;
a main magnet magnetized in the upward and downward directions;
an upper plate attached to said magnet for forming a magnetic circuit;
a yoke for forming the magnetic circuit with said magnet;
a weight for forming a vibrating body with said upper plate and said yoke;
suspension springs for supporting said weight from the upside and downside; and
a ring-shaped auxiliary magnet installed in said yoke.

4. A multifunction actuator according to claim 3, wherein said auxiliary magnet has pole directions oriented differently from those of the main magnets whereby the directions of the magnetic lines of force may not be changed.

5. A multifunction actuator comprising:
a case having an internal space;
a main magnet magnetized in the upward and downward directions;
an upper plate attached to said magnet for forming a magnetic circuit;
a yoke for forming the magnetic circuit with said magnet;
a weight for forming a vibrating body with said upper plate and said yoke;
suspension springs for supporting said weight from the upside and downside;
a sound generating diaphragm directly connected to one end of said weight;
a voice coil cylindrically wound and fixed around the lower end of said diaphragm;
a vibrating coil installed in the lower end of said case for generating vibration by using a portion of magnetic flux generated as above; and
a ring-shaped auxiliary magnet installed in said yoke.

6. A multifunction actuator according to claim 5, wherein said auxiliary magnet has pole directions oriented differently from those of the main magnets whereby the directions of the magnetic lines of force may not be changed.

7. A micro speaker comprising:
a case having an internal space;
a sound generating diaphragm with the outer end fixed to the upper end of said case;
a voice coil cylindrically wound and fixed around the lower end of said diaphragm;
a main magnet magnetized in the upward and downward directions;
an upper plate attached to said magnet for forming a magnetic circuit;
a yoke for forming the magnetic circuit with said magnet; and
a ring-shaped auxiliary magnet installed in said yoke.

8. A micro speaker according to claim 7, wherein said auxiliary magnet has pole directions oriented differently from those of the main magnets whereby the directions of the magnetic lines of force may not be changed.
